(19) United States
(12) Patent Application Publication
(10) Pub. No.: US 2020/0056422 A1
(43) Pub. Date: Feb. 20, 2020

(54) INSULATING GLAZING UNIT, IN PARTICULAR A TRIPLE INSULATING GLAZING UNIT, AND METHOD FOR PRODUCING AN INSULATING GLAZING UNIT

(71) Applicant: SAINT-GOBAIN GLASS FRANCE, Courbevoie (FR)

(72) Inventors: Hans-Werner KUSTER, Aachen (DE); Walter SCHREIBER, Aachen (DE); Marc MAURER, Saint Jean aux Bois (FR)

(21) Appl. No.: 16/342,772

(22) PCT Filed: Oct. 17, 2017
(86) PCT No.: PCT/EP2017/076401

§ 371 Date: Apr. 17, 2019

(30) Foreign Application Priority Data
Oct. 18, 2016 (EP) 16194313.9

(51) Int. Cl. E06B 3/663; E06B 3/673; E06B 3/677

(52) U.S. Cl. CPC E06B 3/66366; E06B 3/66328; E06B 3/6617; E06B 3/6775; E06B 3/67326

(57) ABSTRACT

An insulating glazing unit, in particular a triple insulating glazing unit, includes at least one spacer shaped to form a peripheral spacer frame and defining an inner region, a first outer pane, which is arranged on a first pane contact surface of the spacer frame and a second outer pane, which is arranged on a second pane contact surface of the spacer frame, at least one central pane, which is introduced into at least one intermediate space of at least one retaining profile and which retaining profile is shaped to form a peripheral retaining profile frame, which frames the central pane, wherein the central pane is arranged with the retaining profile frame within the inner region of the spacer frame and between the outer panes.

The present invention relates to an insulating glazing unit, and in particular a triple insulating glazing unit, as well as a method for producing an insulating glazing unit and use thereof.

The thermal conductivity of glass is lower by roughly a factor of 2 to 3 than that of concrete or similar building materials. However, since, in most cases, panes are designed significantly thinner than comparable elements made of brick or concrete, buildings frequently lose the greatest share of heat via external glazing. The increased costs necessary for heating and air-conditioning systems make up a part of the maintenance costs of the building that must not be underestimated. Moreover, as a consequence of more stringent construction regulations, lower carbon dioxide emissions are required. Triple insulating glazing units or multi-glazing units with more than three panes, without which, primarily as a result of increasingly rapidly rising prices of raw materials and more stringent environmental protection constraints, it is no longer possible to imagine the building construction sector, are an important approach to a solution for this.

Triple insulating glazing units usually include three panes made of glass or polymeric materials that are separated from one another by two individual spacers. Another pane is placed on a double glazing by means of an additional spacer. During assembly of such a triple glazing unit, very small tolerances must be maintained since the two spacers must be attached at exactly the same height. Thus, compared to double glazing units, the assembly of triple glazing units is significantly more complex, since either additional plant components must be provided for the assembly of another pane or a time-consuming multipass through a conventional plant is necessary. Such spacers are known, for example, from EP 0 852 280 A1.

WO 2010/115456 A1, WO 2014/198431 A1, and WO 2016/046081 A1 disclose hollow profile spacers with a plurality of hollow chambers for multiple glass panes that include two outer panes and one or a plurality of central panes. There, the central panes are in each case mounted in a groove-shaped accommodating profile of the spacer. The spacer can be made both of polymeric materials and also consist of rigid metals, such as stainless-steel or aluminum.

The spacers described in WO 2010/115456 A1, WO 2014/198431 A1, and WO 2016/046081 A1, which can accommodate a central pane in a groove, have the advantage that only one single spacer has to be installed and, thus, the step of adjustment of two individual spacers in the prior art triple glazing units is eliminated. In order to avoid rattling and wobbling of the central pane, the central pane is secured using a gasket. The gasket contains or is made of in particular an adhesive based on butyl, acrylate, or hotmelt. However, at the same time, the gasket also prevents an exchange of air between the inner interpane spaces since the two interpane spaces are hermetically sealed from one another. This has the disadvantage that no pressure equalization between the individual interpane spaces can occur. In the case of temperature differences between the interpane space facing the building interior and the interpane space facing the building exterior, pressure differences between the two interpane spaces develop. If the interpane spaces are hermetically sealed, no equalization can occur, as a result of which there is high mechanical loading of the central pane. In order to increase the stability of the central pane, thicker and/or prestressed panes must be used. This results in increased material and production costs.

An object of the present invention is, consequently, to provide an improved insulating glazing unit that can be produced economically and in an environmentally friendly manner.

The object of the present invention is accomplished according to the invention by an insulating glazing unit according to the independent claim 1. Preferred embodiments of the invention are apparent from the dependent claims.

The invention comprises an insulating glazing unit, at least comprising:
at least one spacer that is shaped to form a peripheral spacer frame and which frames an inner region,
a first outer pane, which is arranged on a first pane contact surface of the spacer frame and a second outer pane, which is arranged on a second pane contact surface of the spacer frame,
at least one central pane, which is introduced into at least one intermediate space of at least one retaining profile and the retaining profile is shaped to form a peripheral retaining profile frame, which frames the central pane,
   wherein the central pane with the retaining profile frame is arranged within the inner region of the spacer frame and between the outer panes.

One advantageous embodiment of the invention is a triple insulating glazing unit with exactly three panes: a first outer pane, a second outer pane, and a central pane. Another advantageous embodiment of the invention is a quadruple insulating glazing unit with exactly four panes: a first outer pane, a second outer pane, and two central panes. Of course, quintuple insulating glazing units or insulating glazing units with six or more panes according to the invention can also be produced.

The invention thus includes a module made up of the central pane that is anchored in an intermediate space of the retaining profile and is completely framed by the retaining profile to form a retaining profile frame.

It is understood that the retaining profile and the spacer are two separate components, independent of one another. The retaining profile and spacer are not integrated into a one-piece component. This has the particular advantage that both the spacer and the retaining profile can be optimally coordinated in shape and material to the respective function. Thus, the spacer can be made from a harder plastic, for example, from a glass-fiber-reinforced plastic, and can give the insulating glazing unit a certain stability before and during incorporation into a frame. At the same time, the retaining profile can be optimized for the tension-free installation of the central pane(s): for example, by selection of a softer plastic, which reliably secures the central pane(s), on the one hand, but nevertheless permits a certain movement and is flexible during thermal expansion of the central pane. At the same time, in a simple manner, the retaining profile can be designed such that a slight gas exchange and pressure equalization can occur in the entire inner region (for example, by gaps, production tolerances, selective recesses, openings, and holes) and in particular a gas and pressure equalization between a first inner subregion (between the first outer pane and the central pane) and a second inner subregion (between the central pane and the second outer pane).

Because of this low-tension or tension-free installation, the central pane can be selected thinner than in prior art insulating glazing units, resulting in a savings of weight and material. Furthermore, the central pane can be provided with functional coatings that would result in one-sided heating of the central pane or of the interpane space between the central pane and one of the outer panes. Temperature expansions that develop can be compensated in a wide range by the retaining profile according to the invention.

Since the spacer has no direct holding function relative to the central pane(s), an economical, standardized spacer can be used for double glazing units. Such spacers are technically quite developed and optimized in terms of their sealing function and their thermal insulation properties. Despite the gas and pressure equalization in the interior of the insulating glazing unit, the sealing function of the spacer and the hermetic sealing of the inner region of the insulating glazing unit are maintained as with prior art double or multiple glazing units. All of this was unexpected and surprising for the person skilled in the art.

In an advantageous embodiment, the spacer consists of a first pane contact surface and an oppositely arranged second pane contact surface that are joined by an inner surface and an outer surface to form at least one hollow chamber.

In an advantageous embodiment of a spacer frame according to the invention, the inner region is completely framed by the spacer frame. The inner region is the volume that is delimited by the width, length, and height of the interior of the spacer frame. In the finished insulating glazing unit, the side faces of the spacer opposite one another are joined to the outer panes such that the inner region is delimited by the spacer frame and the corresponding regions of the two outer panes.

In an advantageous embodiment, the retaining profile includes a main body, preferably a rectangular main body, that has two retaining strips on the side facing the central pane, wherein the retaining strips form an intermediate space in which the central pane can be arranged. This has the particular advantage that the retaining strips can be designed very small and visually unobtrusive and, thus, the retaining profile frame can be designed very light in weight and aesthetically attractive.

In a particularly advantageous embodiment, the retaining profile consists of a main body, preferably a rectangular main body, that has two retaining strips on the side facing the central pane, wherein the retaining strips form an intermediate space in which the central pane can be arranged.

Advantageously, the main body of the retaining profile has a height h_{H} of 0.2 mm to 5.0 mm and particularly preferably von 0.5 mm to 2.0 mm. Advantageously, the main body of the retaining profile has a width b_{H} of 10.0 mm to 70.0 mm and particularly preferably of 20.0 mm to 50.0 mm.

Advantageously, the retaining strips have a height hₕ of 0.1 mm to 7.0 mm and particularly preferably of 0.5 mm to 3.0 mm. Advantageously, the retaining strips have a width bₕ of 0.1 mm to 2.0 mm and particularly preferably of 0.5 mm to 1.0 mm. The distance between the retaining strips can vary widely and can be adapted to the thickness of the central pane such that it is securely anchored.

In an advantageous embodiment, the retaining profile includes a main body, preferably a rectangular main body, wherein a groove that forms the intermediate space to accommodate the central pane is molded into the side of the main body facing the central pane. In a particularly advantageous embodiment, the retaining profile consists of a main body, preferably a rectangular main body, wherein a groove that forms the intermediate space to accommodate the central pane is molded into the side of the main body facing the central pane. The width of the groove can vary widely and is adapted to the thickness of the central pane such that it can be securely fixed.

In an advantageous development of the invention, the main body has two, three, or more intermediate spaces on the side facing the central pane that serve to accommodate and secure two, three, or more central panes. Thus, in a manner particularly simple from a process technology standpoint, a quadruple, quintuple, or multiple glazing unit can be produced with a total of more than five panes.

In an advantageous embodiment of the invention, the main body has at least two spacing strips, and preferably four spacing strips, on the side facing away from the central pane. Advantageously, the spacing strips have a height hₐ of 0.1 mm to 1 mm and particularly preferably of 0.2 mm to 0.5 mm. Advantageously, the spacing strips have a width bₐ of 0.1 mm to 1 mm and particularly preferably of 0.2 mm to 0.5 mm.

The spacing strips can be continuous and can extend over the entire length of the respective main body of the retaining profile. Alternatively, the spacing strips can be discontinuous and run only in sections along the main body of the retaining profile. The length of the discontinuity is preferably from 0.5 mm to 50 cm, particularly preferably 1 cm to 20 cm.

In an advantageous embodiment, the spacing strips or the discontinuous spacing strips are arranged on both sides relative to the intermediate space on the surface of the main body facing away from the intermediate space.

In an advantageous embodiment of the invention, the retaining profile is made in one piece and preferably from a solid material, in other words, without hollow spaces in the interior of the retaining profile.

In an advantageous embodiment of the invention, the retaining profile is made of plastic, preferably of a plastic that is softer than the material of the spacer.

The retaining profile preferably contains polyethylene (PE), polycarbonates (PC), polystyrene, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene-polycarbonate (ABS/PC), styrene acrylonitrile (SAN), PET/PC, polypropylene (PP), PBT/PC, and/or copolymers or mixtures thereof.

Particularly preferably, the retaining profile is made of polyethylene (PE), polycarbonates (PC), polystyrene, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene-polycarbonate (ABS/PC), styrene acrylonitrile (SAN), PET/PC, polypropylene (PP), PBT/PC, and/or copolymers or mixtures thereof.

The retaining profile can be glass-fiber-reinforced. Through the selection of the glass fiber content in the retaining profile, the coefficient of thermal expansion can be varied and adapted. Through adaptation of the coefficient of thermal expansion of the retaining profile, temperature-induced tensions between the different materials can be avoided. The retaining profile preferably has a glass fiber content of 20% to 50%, particularly preferably of 30% to 40%. At the same time, the glass fiber content in the retaining profile improves strength and stability.

The retaining profile can be made of a solid material. Alternatively, the retaining profile can be made of a foamed material, in particular a foamed plastic, for example, the foamed, above-mentioned plastics. Through the respective level of foaming, the hardness of the plastic can be selectively adjusted.

In another advantageous embodiment of the invention, the retaining profile contains or is made of natural or synthetic rubber, preferably butadiene rubber (BR), styrene butadiene rubber, acrylonitrile butadiene rubber (NBR), butyl rubber (IIR), ethylene propylene diene rubber (EPDM), chloroprene rubber (CR), and/or polyisoprene rubber (IR).

In another advantageous embodiment of the invention, the retaining profile contains or is made of a metal, such as aluminum or stainless steel.

In an advantageous embodiment of the invention, the retaining profile has at least one through opening that joins the side of the retaining profile facing the central pane to the side facing away from the central pane. The openings facilitate the gas exchange during filling of the insulating glazing unit with protective gas as well as the diffusion of moisture out of the inner region to a desiccant in hollow chambers of the spacer. The openings provide a gas-permeable passage from the outside of the retaining profile to the inner region of the pane. The openings have a preferred size of 0.1 mm×0.1 mm to 5 mm×5 mm and can preferably be square, rectangular, circular, elliptical or have any shape.

In an advantageous embodiment, at least one or at least two or at least three, preferably exactly one or exactly two or exactly three or exactly four or exactly five or exactly six or exactly seven or exactly eight or exactly ten or exactly eleven or exactly twelve openings are arranged on each side relative to the intermediate space in the main body of the retaining profile.

Particularly advantageous is a combination of through openings in the retaining profile and spacing strips, in particular with discontinuous spacing strips that are arranged only in sections along the main body of the retaining profile. The openings and the discontinuities of the spacing strips are, for example, arranged such that a gas exchange can occur between the different inner (sub)regions. In other words, the openings and spacing strips form a channel system through which an unimpeded gas exchange can occur.

The openings according to the invention and/or spacing strips in the main body of the retaining profile have in each case, in isolation, and in particular in combination, several particular advantages.

First, they facilitate the escape of air or protective gas from the enclosed intermediate space (inner subregion) during assembly of the retaining profile frame with the central pane in the inner region of the spacer frame. Moreover, the gas exchange during the filling of the inner (sub)regions between the panes with protective gas. Moreover, the diffusion of moisture out of the inner (sub)regions between the panes to the desiccant in the hollow chamber of the spacer is facilitated.

Moreover, pressure fluctuations between the inner subregions are more easily compensated. These are based on the fact that insulating glazing units are subject, in everyday use, to strong temperature fluctuations and temperature differences between the inner side and the outer side. These arise, for example, due to different temperatures in the inner and outer region of the insulating glazing unit as well as heating from sunlight and cooling from shadows. With insulating glazing units one of the panes is often coated, for example, by an infrared reflecting coating that is transparent to visible light. With multiple glazing units having more than two panes, the inner pane (also referred to as the central pane) is often coated, for example, by an infrared reflecting coating that is transparent to visible light. Such coatings heat up greatly with sunlight such that particularly large temperature differences result.

The pane interior (also referred to as the inner region) of insulating glazing units is usually hermetically sealed to prevent gas and moisture exchange with the surroundings. The temperature fluctuations to which the glazing unit is exposed result in different temperatures in the gas-filled, sealed inner subregions between the individual panes and, thus, in a different volume change of the gas in the inner subregions. This results in undesirable mechanical loading of the central pane(s) and ultimately in the fact that the central pane(s) must be dimensioned with a greater thickness.

As a result of the system comprising openings and/or spacing strips, pressure equalization between the inner subregions can occur and the mechanical loading of the central pane(s) can be reduced. Consequently, the central pane can be particularly thin.

The spacer includes a spacer main body. The spacer main body preferably contains or is made of polyethylene (PE), polycarbonates (PC), polystyrene, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene-polycarbonate (ABS/PC), styrene acrylonitrile (SAN), PET/PC, polypropylene (PP), PBT/PC, and/or copolymers or mixtures thereof.

The spacer main body is preferably glass fiber reinforced. Through the selection of the glass fiber content in the spacer main body, the coefficient of thermal expansion of the spacer main body can be varied and adapted. Through adaptation of the coefficient of thermal expansion of the spacer main body and the insulating film, temperature-induced tensions between the different materials and flaking of the insulating film can be avoided. The spacer main body preferably has a glass fiber content of 20% to 50%, particularly preferably of 30% to 40%. At the same time, the glass fiber content in the spacer main body improves strength and stability.

The spacer main body preferably has, along the side facing the inner region, a width b_{A} of 10 mm to 70 mm, particularly preferably 20 mm to 50 mm. The precise width b_{A} is governed by the dimensions of the insulating glazing unit and the desired size of the inner region. The spacer main body preferably has, along the pane contact surfaces, a total height of 5 mm to 8 mm, particularly preferably 6.5 mm.

The spacer main body preferably has at least one hollow chamber. The spacer preferably has a desiccant. The desiccant can either be integrated within the hollow chamber or in the spacer main body itself. The desiccant can then be filled into the hollow chamber immediately before the assembly of the insulating glazing unit. Thus, a particularly high absorption capacity of the desiccant is ensured in the finished insulating glazing unit. The desiccant preferably contains or is made of silica gels, molecular sieves, CaCl₂, Na₂SO₄, activated carbon, silicates, bentonites, natural zeolites, synthetic zeolites, and/or mixtures thereof.

In an advantageous embodiment of the invention, the inner region between the outer panes and within the spacer frame is filled with a protective gas, preferably with an inert gas and particularly preferably with argon, krypton, or mixtures thereof. As a result, particularly good thermal insulation (=a particularly low heat transfer value) of the insulating glazing unit can be achieved.

In an advantageous embodiment of an insulating glazing unit according to the invention—an outer region contains a seal, preferably made of an organic polysulfide, completely peripherally between an outer surface of the spacer frame and the outer edges of the outer panes, and
the pane assembly comprising the outer panes and the spacer frame is hermetically sealed.

As a result, an insulating glazing unit with particularly low gas exchange and particularly good thermal insulation can be obtained.

The invention further includes an insulating glazing unit comprising at least two outer panes, a spacer peripherally arranged between the outer panes in the edge region of the outer panes, a module comprising a central pane and a retaining profile frame arranged in the inner region, an adhesive connection comprising an adhesive with sealing properties and an external sealing layer. An adhesive is applied between the first outer pane and the first pane contact surface and the second outer pane and the second pane contact surface as a sealant and for stabilization. The spacer frame is set back relative to the outer edges of the outer panes such that the two outer panes protrude beyond the spacer. The peripheral intermediate space thus formed in the outer region between the spacer and the outer panes is filled with a seal, preferably a plastic sealing compound. The outer space is positioned opposite the inner region and is delimited by the two outer panes and the spacer. The seal is in contact with the insulating film of the spacer. The seal preferably contains polymers or silane-modified polymers, particularly preferably polysulfides, silicones, RTV (room-temperature vulcanizing) silicone rubber, HTV (high-temperature vulcanizing) silicone rubber, peroxide-vulcanizing silicone rubber, and/or addition-vulcanizing silicone rubber, polyurethanes, butyl rubber, and/or polyacrylates.

The outer panes and the central pane(s) contain materials such as glass, in particular soda lime glass and/or transparent polymers. The outer panes and the central pane(s) preferably have optical transparency of >85%. In principle, various geometries of the outer panes and the central pane(s) are possible, for example, rectangular, trapezoidal, and rounded geometries. The outer panes and the central pane(s) preferably have a thermal protection coating. The thermal protection coating preferably contains silver.

In an advantageous embodiment of the insulating glazing unit according to the invention, the module is formed by the central pane and the retaining profile frame such that a gas and/or pressure exchange between a first inner subregion (between the first outer pane and the central pane) and a second inner subregion (between the central pane and the second outer pane) can occur.

For this, the retaining profile frame is preferably dimensioned such that the contact surface of the retaining profile frame with a spacer frame has cutouts or gas-permeable regions, for example, gaps, production tolerances, or holes. In other words, the retaining profile frame is arranged non-sealingly in the spacer frame. In isolation or in combination therewith, the retaining profile frame can have openings in the main body that enable gas and pressure exchange. In isolation or in combination therewith, the material of the retaining profile frame can be selected so soft that a certain pressure equalization is effected by a slight movement of the central pane toward one of the outer panes. In isolation or in combination therewith, the spacing strips can have discontinuities or cutouts that enable gas and pressure equalization.

Another aspect of the invention comprises a method for producing an insulating glazing unit and in particular a triple insulating glazing unit, wherein at least
a) at least one central pane is introduced into at least one intermediate space of at least one retaining profile and the retaining profile is shaped to form a peripheral retaining profile frame that frames the central pane, and
   a first outer pane is joined to a first pane contact surface of a spacer, wherein the spacer is shaped to form a peripheral spacer frame in the edge region of the first outer pane and an inner region is preferably completely framed,
b) the central pane with the retaining profile frame is arranged in the inner region of the spacer frame,
c) a second outer pane is joined to a second pane contact surface of the spacer, and
d) the pane assembly comprising the first outer pane, the second outer pane, and the spacer frame is pressed together and fixedly bonded.

Thus, the inner region with the module comprising the central pane and the retaining frame is hermetically sealed and the module is securely fixed in the inner region of the insulating glazing unit.

In a development of the method according to the invention for producing an insulating glazing unit according to the invention, after the step c) and before the step d), the inner region between the outer panes is filled with a protective gas, preferably with an inert gas and particularly preferably with argon, krypton, or mixtures thereof.

In a development of the method according to the invention, after the pane assembly comprising the first outer pane, the second outer pane, and the spacer frame is sealed and pressed together, a seal is filled in peripherally and preferably completely peripherally in the outer region between the outer surface of the spacer frame and the outer edges of the outer panes.

The filling of the inner region with a protective gas can be done, for example, through two passages arranged on different and preferably opposite sides of the spacer frame, which allow the passage of gas from the outside to the inner region and from the inner region outward. Thus, the air situated in the inner region can be sucked out through the first gas passage, and the protective gas can be filled into the inner region through the second gas passage. Both passages are sealed by a sealant after the filling of the protective gas and sealed by the seal.

The insulating glazing unit according to the invention and in particular the triple insulating glazing unit according to the invention is preferably used in construction and architecture indoors and outdoors.

In the following, the invention is explained in detail with reference to drawings and examples. The drawings are purely schematic representations and not true to scale. They in no way restrict the invention. They depict:

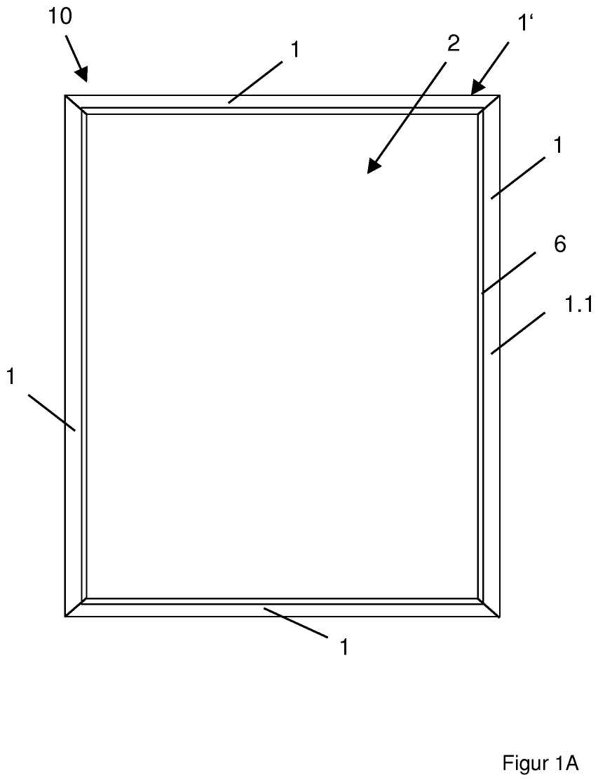

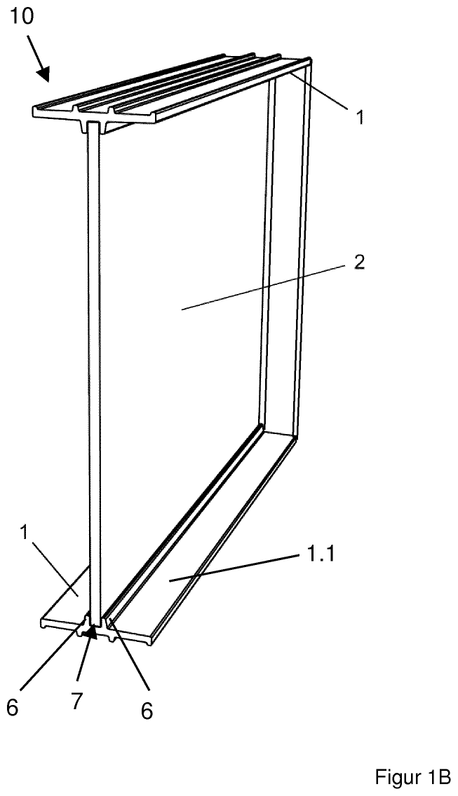

FIG. 1A a plan view of a central pane framed by a retaining profile frame;

FIG. 1B a perspective view of a cross-section through the central pane framed by a retaining profile frame of FIG. 1A;

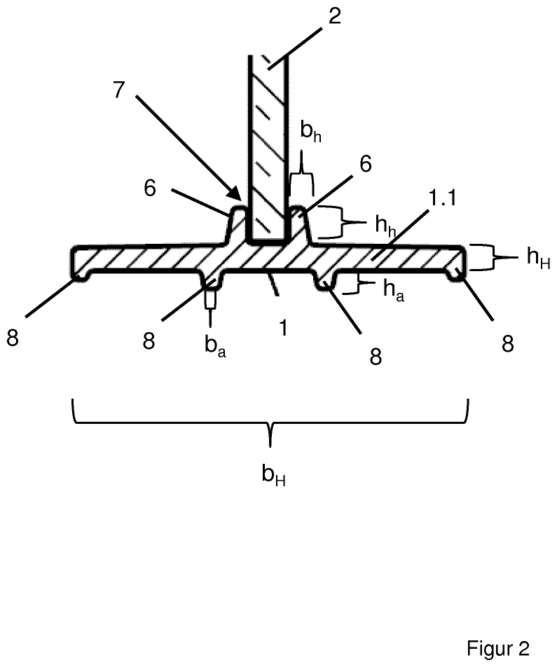

FIG. 2 a detail of the central pane with a retaining profile;

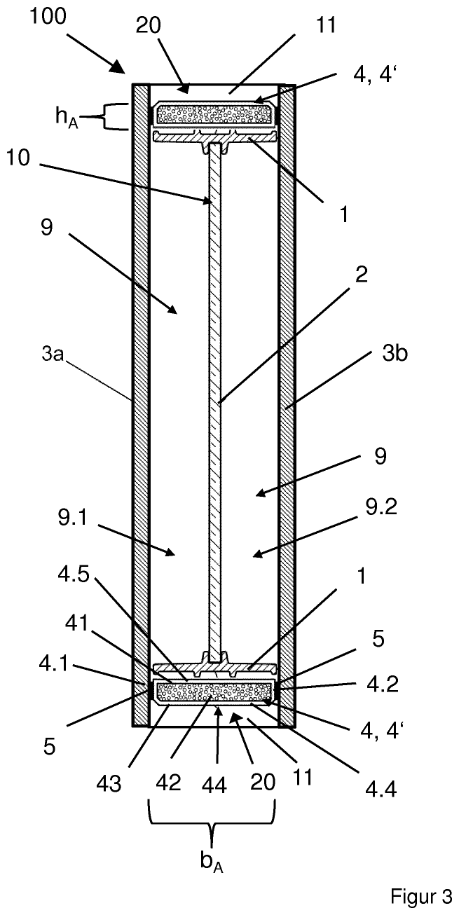

FIG. 3 a cross-sectional view of the insulating glazing unit according to the invention;

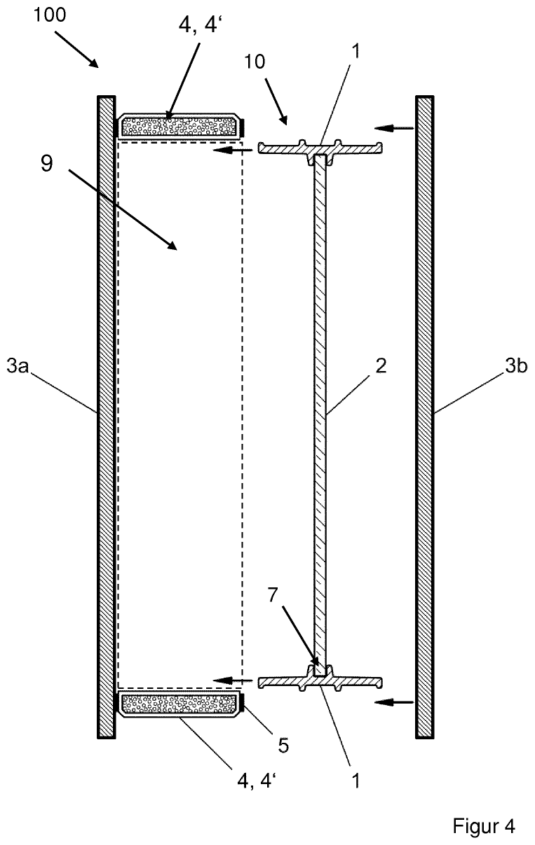

FIG. 4 a schematic view of an insulating glazing unit according to the invention during the method according to the invention;

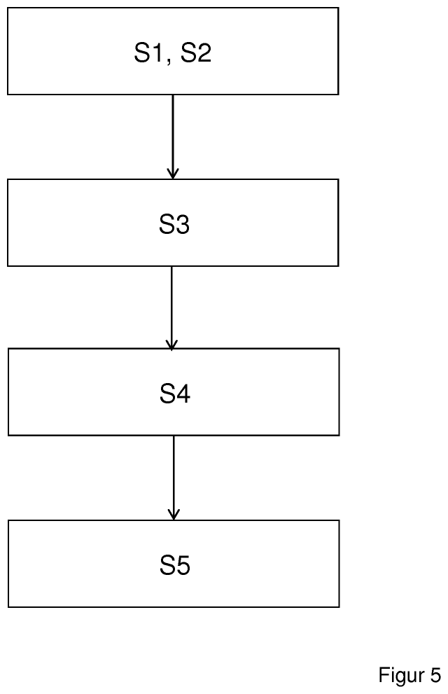

FIG. 5 a flowchart of a possible embodiment of the method according to the invention; and

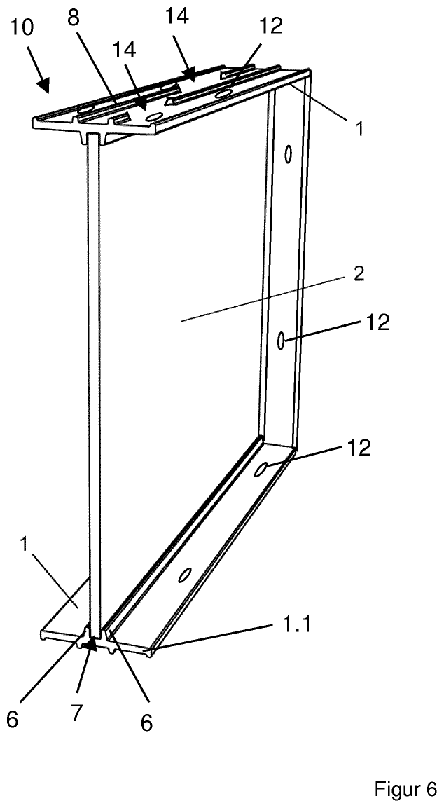

FIG. 6 a perspective view of a cross-section through an alternative embodiment of a module according to the invention.

FIG. 1A depicts a plan view of a central pane 2 framed by a retaining profile frame 1′ according to the invention. FIG. 1B depicts a perspective view of a cross-section through the central pane 2 framed by the retaining profile frame 1′ according to the invention of FIG. 1A.

The retaining profile frame 1′ consists of four sections of the retaining profile 1, which are in each case arranged on the sides of the rectangular central pane 2. The four sections of the retaining profile 1 are joined in the corners of the central pane 2 at a 90° angle in each case. The main body 1.1 of the retaining profile 1 has two retaining strips 6, wherein in the view of FIG. 1A, only the retaining strip 6 positioned at the top in the plane of the figure is visible, since in the projection through the central pane 2, the retaining strips 6 are arranged congruently one above another. The two retaining strips 6 form an intermediate space 7. The edge region of the central pane 2 is in each case set into the recess 7 and is secured in the retaining profile frame 1′ by the retaining strips 6.

The result is a module 10 comprising the central pane 2, which is anchored in the intermediate space 7 formed by the retaining strips 6 of the retaining profile 1 and is completely framed by the retaining profile 1 to form a retaining profile frame 1′.

The retaining profile 1 consists in this example of a solid main body 1.1 without hollow spaces in the interior. The retaining profile 1 comprising the main body 1.1, the retaining strips 6, and the spacing strips 8 is, for example, one piece and made of a single material. The retaining profile 1 is made, for example, from a solid material; in other words, the retaining profile 1 is formed without hollow spaces. The retaining profile 1 is made, for example, of foamed styrene acrylonitrile (SAN). The plastic of the retaining profile 1 is selected soft such that it enables largely tension-free mounting of the central pane 2, but at the same time, still securely fixes the central pane 2. The width b_{H} of the main body 1.1 of the retaining profile 1 is, for example, 20 mm. The thickness, i.e. the height h_{H} of the main body 1.1 of the retaining profile 1 is, for example, 1.5 mm. The height hₕ of a retaining strip 6 is, for example, 3 mm; the width bₕ is, for example, 1 mm.

FIG. 2 depicts a detail of a cross-section of a central pane 2 that is secured in a retaining profile 1. The retaining profile has a rectangular main body 1.1. The main body 1.1 has two retaining strips 6 on the side facing the central pane 2, which form an intermediate space 7. The central pane 2 is arranged in the edge region in the intermediate space 7. The main body 1.1 has four spacing strips 8, on the side facing away from the central pane 2, for example. The spacing strips 8 facilitate the sliding of the module 10 comprising the central pane 2 and the retaining profile frame 1′ into the subsequent insulating glazing unit 100. Moreover, the spacing strips 8 facilitate the filling of the interior in the insulating glazing unit 100 with a protective gas. The spacing strips 8 can be continuous and can extend over the entire length of the respective retaining profile 1. Alternatively, the spacing strips 8 can be discontinuous and run only in sections along the retaining profile 1. Moreover, openings can be arranged in the main body (see, in this regard, FIG. 6).

FIG. 3 schematically depicts an insulating glazing unit 100 according to the invention, using the example of a triple insulating glazing unit. The insulating glazing unit 100 comprises a spacer 4 that is shaped to form a peripheral spacer frame 4′ and defines an inner region 9 completely along the frame. A module 10 comprising a central pane 2 that is secured in a retaining profile frame 1′ is arranged in the inner region 9. The module 10 corresponds, for example, to the module 10 that is described in FIGS. 1A, 1B, and 2. The module 10 subdivides the inner region 9 into a first inner subregion 9.1 and a second inner subregion 9.2. The first inner subregion 9.1 is delimited by the first outer pane 3a, a section of the spacer frame 4′, and the central pane 2. The second inner subregion 9.2 is, correspondingly delimited by the second outer pane 3b, a section of the spacer frame 4′, and the central pane 2. The spacer 4 is a customary prior art spacer for two outer panes in a double insulating glazing unit, as is known, for example, from WO 2016/046081 A1.

The first outer pane 3a of the insulating glazing unit 100 is connected via an adhesive connection 5 to the first pane contact surface 4.1 of the spacer 4, while the second outer pane 3b is connected via an adhesive connection 5 to the second pane contact surface 4.2. The adhesive connection 5 additionally has a sealing effect and is made, for example, of polyisobutylene or butyl rubber.

The spacer 4 consists, for example, of a polymeric spacer main body 41 that has at least one hollow chamber 42. The hollow chamber 42 is filled with a desiccant. The desiccant contains, for example, molecular sieves such as natural and/or synthetic zeolites. The spacer main body 41 has, on the surface facing the inner region 9, a plurality of openings (not shown here), enabling a gas exchange between the hollow chamber 42 with the desiccant and the inner region 9. As a result, the desiccant can withdraw moisture from the inner region 9 of the insulating glazing unit 100, preventing an undesirable fogging and increasing, and thus improving, the thermal insulation of the insulating glazing unit 100.

An insulating film 43 is applied on the outer surface 44 of the spacer 4, i.e., on the side of the spacer main body 41 facing away from the central pane 2, which film reduces the heat transfer through the polymeric spacer main body 41 into the inner region 9 of the insulating glazing unit 100. The insulating film 43 can, for example, be secured on the polymeric spacer main body 41 with a polyurethane hot melt adhesive. The insulating film 43 contains, for example, three polymeric layers made of polyethylene terephthalate with a thickness of 12 μm and three metallic layers made of aluminum with a thickness of 50 nm. The metallic layers and the polymeric layers are in each case applied alternatingly, with the two outer layers formed by polymeric layers. In other words, the layer sequence consists of a polymeric layer, followed by a metallic layer, followed by an adhesive layer, followed by a polymeric layer, followed by a metallic layer, followed by an adhesive layer, followed by a metallic layer, followed by a polymeric layer.

The spacer main body 41 is made, for example, of glass-fiber-reinforced styrene acrylonitrile (SAN). The coefficient of thermal expansion of the spacer main body 41 can be varied and adapted through the selection of the glass fiber content in the spacer main body 41. By adapting the coefficient of thermal expansion of the spacer main body 41 and of the insulating film 43, temperature-induced tensions between the different materials and flaking of the insulating film 43 can be avoided. The spacer main body 41 has, for example, a glass fiber content of 35%. At the same time, the glass fiber content in the spacer main body 41 improves strength and stability.

The first outer pane 3a and the second outer pane 3b protrude beyond the spacer 4 such that a peripheral edge region having an outer region 20 is created. The outer region 20 is filled with a seal 11. This seal 11 is formed, for example, by an organic polysulfide. Thus, optimal mechanical stabilization of the edge seal is achieved. At the same time, the inner region is protected against penetrating moisture and foreign influences from the outside.

The first outer pane 3a and the second outer pane 3b are made, for example, of soda lime glass with a thickness of 3 mm, whereas the central pane 2 is formed from soda lime glass with a thickness of 2 mm. The first outer pane 3a and the second outer pane 3b have, for example, dimensions of 1000 mm×1200 mm, whereas the central pane 2 has dimensions of 980 mm×1180 mm.

FIG. 4 schematically depicts the individual steps of a method according to the invention for producing an insulating glazing unit 100 according to the invention. FIG. 5 depicts a flowchart of a possible embodiment of the method according to the invention.

S1: In a first step S1, a module 10 is formed. For this, a central pane 2 is introduced into an intermediate space 7 of a retaining profile 1 introduced and four sections of the retaining profile 1 are shaped to form a complete peripheral retaining profile frame 1′, which frames the central pane 2.

S2: In a second step S2, a first outer pane 3a is joined to a first pane contact surface 4.1 of a spacer 4, wherein the spacer 4 is shaped to form a peripheral spacer frame 4′ in the edge region of the first outer pane 3a. The spacer frame 4′ frames an inner region 9 (depicted in FIG. 4 as a dashed frame). The inner region 9 is the volume delimited, in width, length, and height, in the interior of the spacer frame. The spacer frame 4′ is offset inwardly in the edge region of the first outer pane 3a and forms an outer region 20 between the outer perimeter of the spacer frame 4′ and the edge of the first outer pane 3a. The connecting of the first pane contact surface 4.1 of the spacer 4 to the first outer pane 3a is done via an adhesive connection 5 using an adhesive that was applied to the first pane contact surface 4.1 before the connecting.

Of course, the steps S1 and S2 can also be carried out simultaneously or in reverse order.

S3: In a third step S3, the module 10 comprising the central pane 2 and the retaining profile frame 1′ is arranged in the inner region 9 of the spacer frame 4′. Spacer frame 4′ and retaining profile frame 1′ were coordinated such that the retaining profile frame 1′ can be arranged precisely fitting within the spacer frame 4′. Specifically, the width b_{H} of the retaining profile 1 is equal to or slightly less than the width b_{A} of the spacer 4. The central pane 2 is arranged parallel to the first outer pane 3a and thus at a constant distance therefrom.

S4: In a fourth step S4, a second outer pane 3b is joined to a second pane contact surface 2.2. The connecting is done via an adhesive connection 5 using an adhesive 5 that was applied to the second pane contact surface 2.2. The module 10 is arranged in the inner region 9 of the spacer frame 4′ between the first outer pane 3a and the second outer pane 3b.

S5: In a fifth step S5, the pane assembly comprising the first outer pane 3a, the second outer pane 3b, and the spacer frame 4′ is pressed together and thus fixedly bonded in a durable manner.

Of course, a quadruple glazing unit or a multiple glazing unit can be produced by arranging two or more modules 10 parallel to one another. Alternatively, a module 10 can also have more than one central pane 2 secured in additional intermediate spaces 7. The additional intermediate spaces 7 can, for example, be formed by additional retaining strips 6. In this manner as well, a quadruple glazing unit or multiple glazing unit can be produced economically.

FIG. 6 depicts a detail of a cross-section through an alternative module 10 according to the invention, wherein a central pane 2 is secured in an alternative retaining profile frame 1′. The retaining profile 1 of the retaining profile frames 1′ has, in this example, a plurality of openings 12 and here, for example, two openings 12 per side, into which the retaining profile main body 1.1 has pierced. The openings 12 form a through cutout from the side facing the central 2 to the side facing away from the central pane 2. The openings 12 facilitate, among other things, the exchange of gas during filling of the insulating glazing unit with protective gas as well as the diffusion of moisture out of the inner region 9 to the desiccant in the hollow chambers 42 of the spacer 4. The openings 12 are, for example, circular and have, for example, a diameter of 2 mm.

In the example depicted, four spacing strips 8, for example, are in each case arranged on the retaining profile 1. The spacing strips 8 have a plurality of discontinuities 14, for example, three discontinuities 14 in each case, each with a length of 10 cm. The discontinuities 14 of the spacing strips 8 enable, in particular in combination with the openings 12, a particularly effective and selective gas exchange between the first inner subregion 9.1 and the second inner subregion 9.2, both during the filling with protective gas and also during the subsequent use of the insulating glazing unit 100 at the site of use. The openings 12 and the spacing strips 8 are, for example, arranged such that a gas exchange between the first inner subregion 9.1 and the second inner subregion 9.2 can occur. In other words, the openings 12 and the spacing strips 8 form an open channel system through which a gas exchange can take place.

The combination of openings 12 and spacing strips 8 has a number of special advantages. First, the escape of air or protective gas from the first inner subregion 9.1 during assembly of the retaining profile frame 1′ plus central pane 2 into inner region 9 of the spacer frame 4′ is facilitated. Furthermore, the gas exchange during filling of the inner subregions 9.1,9.2 between the panes with protective gas is facilitated. Furthermore, the diffusion of moisture out of the inner subregions 9.1,9.2 to the desiccant in the hollow chamber 42 of the spacer 4 is facilitated. Furthermore, pressure fluctuations between the two inner subregions 9.1,9.2 are more readily compensated. These result from the fact that, in everyday use, insulating glazing units 100 are subject to strong temperature fluctuations and temperature differences between the inner side and the outer side. These are caused, on the one hand, by different temperatures in the inner and outer region of the insulating glazing unit as well as by heating from sunlight and cooling from shadows. If one of the panes is coated, for example, by an infrared reflecting coating that is transparent to visible light, the effect of asymmetric heating is further amplified. The temperature differences result in temperature fluctuations in the gas-filled, sealed pane inner region 9 and thus in a different volume change of the gas in the inner subregions 9.1,9.2 between the panes. This can result in an undesirable mechanical loading of the central pane 2. By means of the system of openings 12 and discontinuous spacing strips 8, pressure equalization between the inner subregions 9.1,9.2 can occur and the mechanical loading of the central pane 2 is reduced. This was unexpected and surprising for the person skilled in the art.

### LIST OF REFERENCE CHARACTERS

1 retaining profile
1.1 main body of the retaining profile 1
1′ retaining profile frame
2 central pane
3a,3b outer pane
4 spacer
4.1 first pane contact surface
4.2 second pane contact surface
4.4 outer surface
4.5 inner surface
4′ spacer frame
5 adhesive connection
6 retaining strip
7 intermediate space
8 spacing strip
9 inner region
9.1,9.2 inner subregion
10 module
11 seal
12 opening
15 discontinuity
20 outer region
41 spacer main body
42 hollow chamber
43 insulating film
44 outer surface of the spacer 4
45 inner surface of the spacer 4
100 insulating glazing unit
b_{A} width of the spacer 4
bₐ width of the spacing strip 8
b_{H} width of the retaining profile 1
bₕ width of the retaining strip 6
h_{A} height of the spacer 4
hₐ height of the spacing strip 8
h_{H} height of the retaining profile 1
hₕ height of the retaining strip 6
S1,S2,S3,S4,S5 step

1. Insulating glazing unit, comprising:
at least one spacer, shaped to form a peripheral spacer frame and defining an inner region, wherein the spacer consists of a first pane contact surface and an oppositely arranged second pane contact surface that are joined by an inner surface and an outer surface to form at least one hollow chamber,
a first outer pane, which is arranged on the first pane contact surface of the spacer frame and a second outer pane, which is arranged on the second pane contact surface of the spacer frame,
at least one central pane, which is introduced into at least one intermediate space of at least one retaining profile and the retaining profile is shaped to form a peripheral retaining profile frame, which frames the central pane,
wherein the central pane with the retaining profile frame is arranged within the inner region of the spacer frame and between the outer panes and the retaining profile has at least one through opening that connects the side of the retaining profile facing the central pane to the side facing away from the central pane.

2. Insulating glazing unit according to claim 1, wherein the retaining profile includes or consists of a main body, and two retaining strips that form the intermediate space are arranged on the side of the main body facing the central pane.

3. Insulating glazing unit according to claim 1, wherein the retaining profile includes or consists of a main body, and a groove that forms the intermediate space is molded into the main body on the side facing the central pane.

4. Insulating glazing unit according to claim 2, wherein the main body has, on the side facing away from the central pane, at least two spacing strips.

5. Insulating glazing unit according to claim 4, wherein the spacing strips are discontinuous and are arranged only in sections along the main body of the retaining profile.

6. Insulating glazing unit according to claim 1, wherein the retaining profile has at least two through openings.

7. Insulating glazing unit according to claim 1, wherein the retaining profile contains or is made of a plastic.

8. Insulating glazing unit according to claim 1, wherein the retaining profile contains or is made of natural or synthetic rubber, or a metal.

9. Insulating glazing unit according to claim 1, wherein the inner region between the outer panes is filled with a protective gas.

10. Insulating glazing unit according to claim 1, wherein
an outer region between an outer surface of the spacer frame and the outer edges of the outer panes contains, peripherally, a seal, and
the pane assembly comprising the outer panes and the spacer frame is hermetically sealed.

11. Insulating glazing unit according to claim 10, wherein the retaining profile frame is implemented such that a gas exchange can occur between an inner subregion between the first outer pane and the central pane and the inner subregion between the central pane and the second outer pane.

12. Method for producing an insulating glazing unit according to claim 1, the method comprising:
a) introducing at least one central pane into at least one intermediate space of at least one retaining profile and the retaining profile is shaped to form a peripheral retaining profile frame, which frames the central pane, and
joining a first outer pane to a first pane contact surface of a spacer, wherein the spacer is shaped to form a peripheral spacer frame in the edge region of the first outer pane and an inner region is framed,
b) arranging the central pane with the retaining profile frame in the inner region of the spacer frame,
c) joining a second outer pane to a second pane contact surface of the spacer, and
d) pressing together and fixedly bonding the pane assembly comprising the first outer pane, the second outer pane, and the spacer frame.

13. Method for producing an insulating glazing unit according to claim 12, wherein after the step c) and before the step d), the inner region between the outer panes is filled with a protective gas.

14. Method for producing an insulating glazing unit according to claim 12, wherein after the pane assembly comprising the first outer pane, the second outer pane, and the spacer frame is closed and pressed together, a seal is filled peripherally in the outer region between the outer surface of the spacer frame and the outer edges of the outer panes.

15. A method comprising utilizing an insulating glazing unit produced according to claim 1 in construction and architecture indoors and outdoors.

16. Insulating glazing unit according to claim 1, wherein the insulating glazing unit is a triple insulating glazing unit.

17. Insulating glazing unit according to claim 2, wherein the main body is a rectangular main body.

18. Insulating glazing unit according to claim 3, wherein the main body is a rectangular main body.

19. Insulating glazing unit according to claim 4, wherein the main body has, on the side facing away from the central pane, at least four spacing strips.

20. Insulating glazing unit according to claim 6, wherein at least one of the at least two through openings is arranged on one side relative to the intermediate space and at least another one of the at least two through openings is arranged on the opposite side relative to the intermediate space.

21. Insulating glazing unit according to claim 7, wherein the plastic is softer than the material of the spacer and is selected from the group consisting of polyethylene (PE), polycarbonates (PC), polystyrene, polyesters, polyurethanes, polymethyl methacrylates, polyacrylates, polyamides, polyethylene terephthalate (PET), polybutylene terephthalate (PBT), preferably acrylonitrile butadiene styrene, (ABS) acrylonitrile styrene acrylester (ASA), acrylonitrile butadiene styrene-polycarbonate (ABS/PC), styrene acrylonitrile (SAN), PET/PC, polypropylene (PP), PBT/PC, and copolymers and mixtures thereof.

22. Insulating glazing unit according to claim 7, wherein the plastic is foamed.

23. Insulating glazing unit according to claim 8, wherein the rubber is butadiene rubber (BR), styrene butadiene rubber, acrylonitrile butadiene rubber (NBR), butyl rubber (IIR), ethylene propylene diene rubber (EPDM), chloroprene rubber (CR), and/or polyisoprene rubber (IR), and the metal is aluminum or stainless steel.

24. Insulating glazing unit according to claim 9, wherein the protective gas is an inert gas that is argon, krypton, or mixtures thereof.

25. Insulating glazing unit according to claim 10, wherein the seal is made of an organic polysulfide.
